(19) United States
(12) Patent Application Publication
(10) Pub. No.: US 2016/0376860 A1
(43) Pub. Date: Dec. 29, 2016

(54) SUBSEA FILLER LINE SYSTEM AND METHOD FOR TRANSPORTING VARIOUS FLUIDS THROUGH A MASTER FLOW CONDUIT

(71) Applicant: AKER SOLUTIONS AS, Lysaker (NO)

(72) Inventors: Finn Peter GJERULL, Høvik (NO); Sigvard OMVIK, Moss (NO)

(73) Assignee: AKER SOLUTIONS AS, Lysaker (NO)

(21) Appl. No.: 15/105,414

(22) PCT Filed: Dec. 17, 2014
(86) PCT No.: PCT/NO2014/050238

§ 371 Date: Jun. 16, 2016

(30) Foreign Application Priority Data
Dec. 17, 2013 (NO) 20131683

(51) Int. Cl. E21B 23/08; F17D 3/08; E21B 41/00

(52) U.S. Cl. CPC E21B 23/08; E21B 41/0007; F17D 3/08

(57) ABSTRACT

A subsea filler line system adapted to transport different types of fluids in separate batches through one single supply conduit, or flexible line, from the sea surface to respective dedicated storage tanks, or vessels, installed on the seabed, is described. The system includes respective valves and control systems to operate the subsea filler line system. The subsea filler line system includes at least two pigs adapted to be pushed by the transported fluid through said supply conduit, or flexible line, which pigs further provide a barrier between the respective fluids in front of and behind each pig, thus being able to define respective fluid batches between following pigs, each fluid batch being directed by means of valves through an inlet into said supply conduit and an outlet from said supply conduit and further on to the respective dedicated storage tanks, or vessels, on the seabed. A method for transporting various fluids in separate batches through a master flow conduit is also disclosed.

The present invention relates to a subsea filler line system adapted to transport different types of fluids in separate batches through one single supply conduit, or flexible line, from the sea surface to respective dedicated storage tanks, or vessels, installed on the seabed, said system includes respective valves and control systems to operate the subsea filler line system.

The present invention relates to a method for transporting various fluids trough a master flow conduit from the surface to seabed installed tanks or vessels, where respective pig sets are used in combination with a pig launcher and a pig receiver in addition to a number of valves, branch off pipes and a purging fluid, to enable separate transfer of fluid batches.

The scope of the present invention is to be able to transport various fluids in batches via one single fluid conduit from a topside/shore station to a subsea production/process system.

Since the various fluids need to be transported over substantial distances, and by use of one single fluid conduit only, the main challenge is how to enable this. I.e. be able to transfer more than one type of fluid to dedicated storage tanks located subsea on the seabed.

Thus some kind of means was necessary to isolate the respective fluids in order to minimize potential mixing of the fluids.

Probably such a subsea filler line system needs to be water filled during installation. Thus, in one way or another, the water has to be discharged from the filler line system, either to the surrounding sea through a filter or into a grey water tank.

It is contemplated that the filler line system will transport for example MEG for extended periods, and other chemicals and/or hydraulic fluids at intervals.

It is further envisioned that the volume of the various chemicals except for the dominant fluid (e.g. the above indicated MEG) will have storage tank capacities to provide similar service duration between fill-ups.

According to the present invention a subsea filler line system of the introductory said kind is provided, which system is distinguished in that said subsea filler line system includes pigs adapted to be pushed by fluid through said supply conduit, or flexible line, which pigs further provide a barrier between the respective fluids in front of and behind each pig, thus being able to define respective fluid batches between following pigs, each fluid batch being directed by means of valves through an inlet into said supply conduit and an outlet from said supply conduit and further on to the respective dedicated storage tanks, or vessels, on the seabed.

In one embodiment, the subsea filler line system can include a pig launcher comprising a pig stopper able to both retain a pig and release a pig into said supply conduit. Preferably, the pig launcher comprises said fluid inlet and said pig stopper, which inlet and pig stopper is spaced apart by at least on pig length.

In one embodiment, the subsea filler line system can include a pig lock adjacent to the subsea storage tanks comprising a pig stopper able to both retain a pig and discharge a pig into a pig receiver, which pig receiver may be retrievable to the surface as an option. Preferably, said pig lock comprises said fluid outlet and said pig stopper, which outlet and pig stopper is spaced apart by at least on pig length.

In another embodiment the subsea filler line system can include a battery of subsea storage tanks interconnected by a pipe manifold, which pipe manifold has a respective branch pipe to each individual storage tank, each respective branch pipe being provided with an inlet valve able to shut off/open up the flow to said storage tank by means of said control system.

Each subsea storage tank, or respective branch pipe, can include a fluid pipe with a shut off/open up valve extending to dedicated equipment on a subsea installation, said valve being operated by means of said control system.

Further, the single supply conduit can include a first shut off/open up mainline valve adjacent to the pig launcher and a second shut off/open up mainline valve adjacent to the pig lock on the seabed, which valves being operable by means of said control system and enables installation/replacement of said single supply conduit.

In still another embodiment, the single supply conduit can include a third shut off/open up mainline valve adjacent to, but in the extension of the pig lock on the seabed, which valve being operated by means of said control system and enables isolation of the subsea filler system when replacing the pig receiver.

According to the present invention also a method of the introductory said kind is provided, a subsea filler line system of the introductory said kind is provided, which is distinguished in that predetermined valves are operated either to open up or shut down a flow, in combination with operation of the pig launcher to send out one pig at the time to create a fluid partition between each fluid batch transported through said master flow conduit.

### EXAMPLE OF EMBODIMENT

While the various aspects of the present invention has been described in general terms above, a more detailed and non-limiting example of an embodiment will be described in the following with reference to the drawings, in which

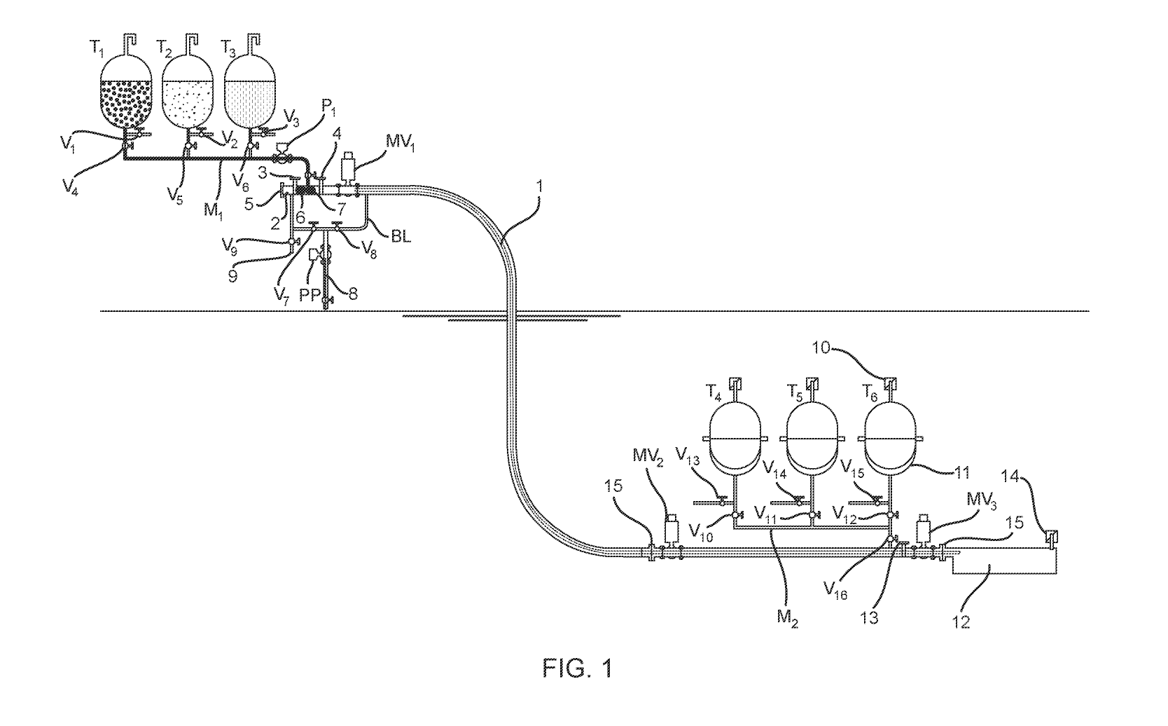

FIG. 1 is a schematic view of a subsea filler line system according to the present invention in a first stage of operation.

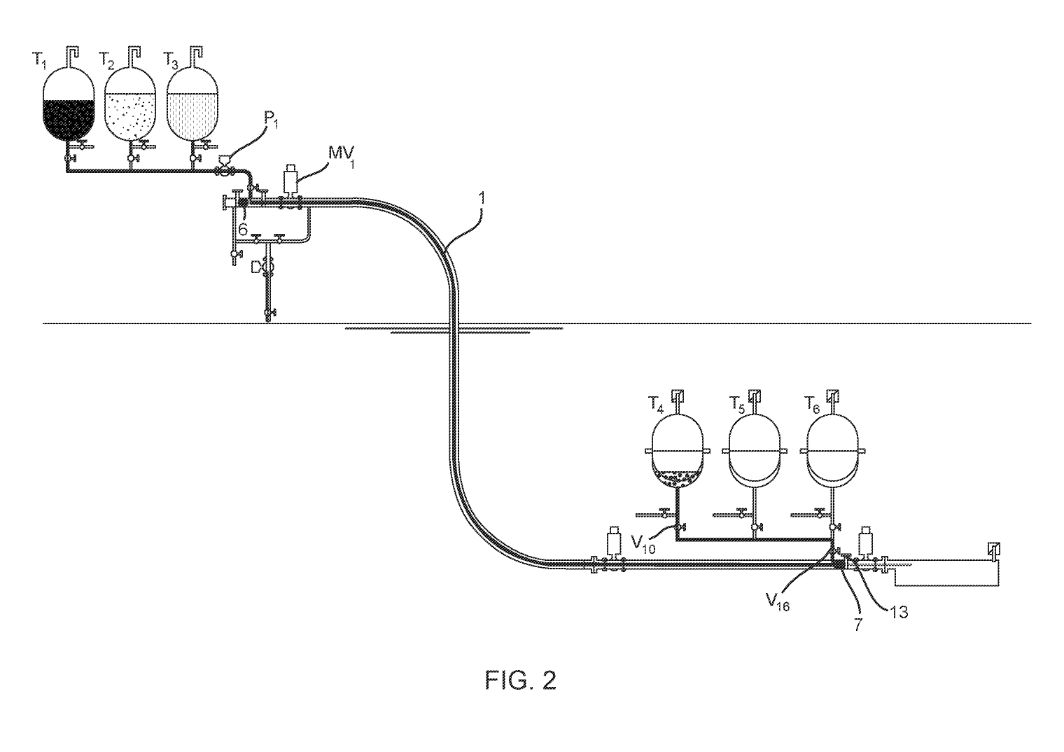

FIG. 2 is a schematic view of a subsea filler line system according to the present invention in a second stage of operation.

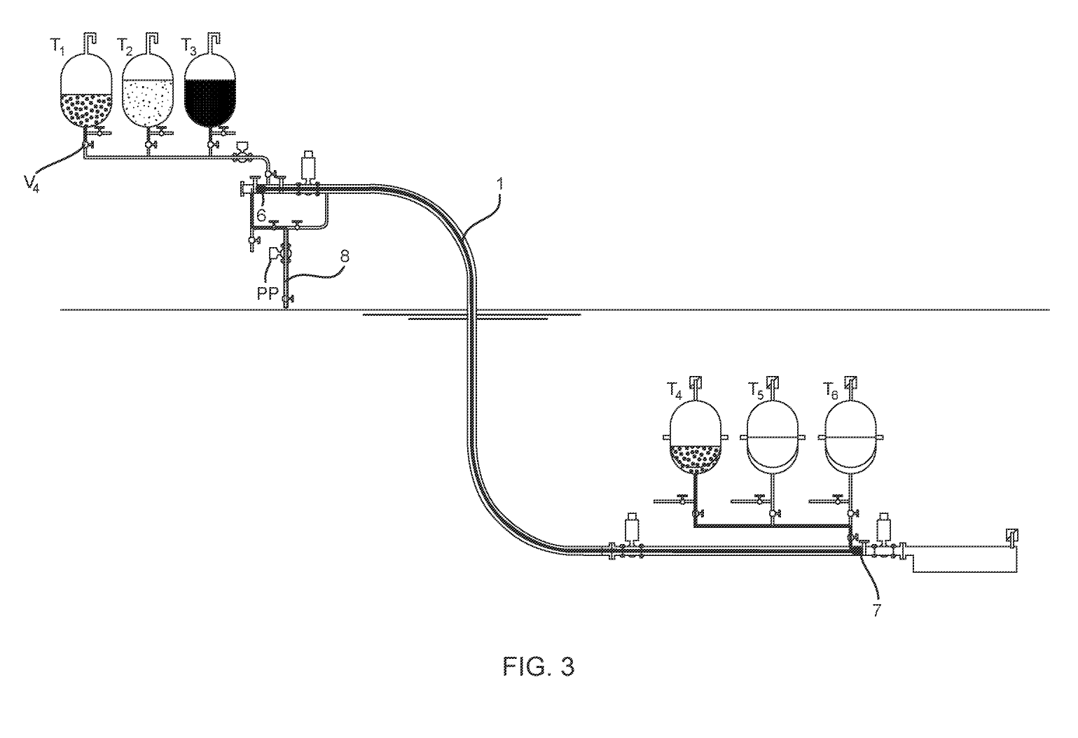

FIG. 3 is a schematic view of a subsea filler line system according to the present invention in a third stage of operation.

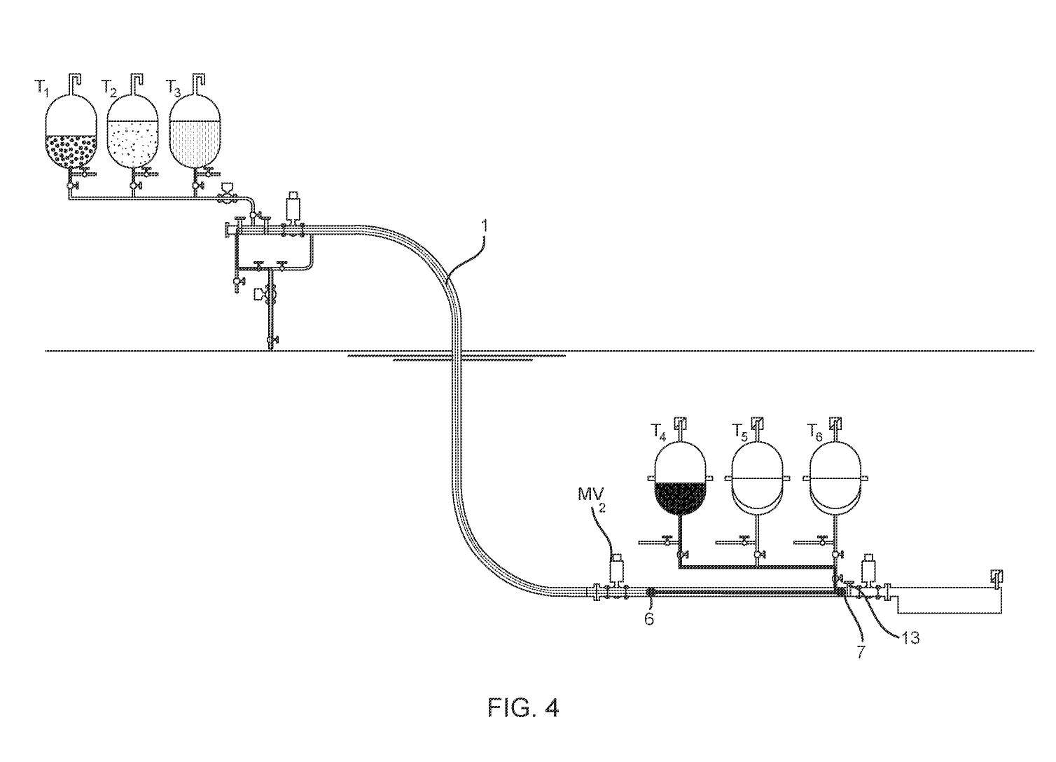

FIG. 4 is a schematic view of a subsea filler line system according to the present invention in a fourth stage of operation.

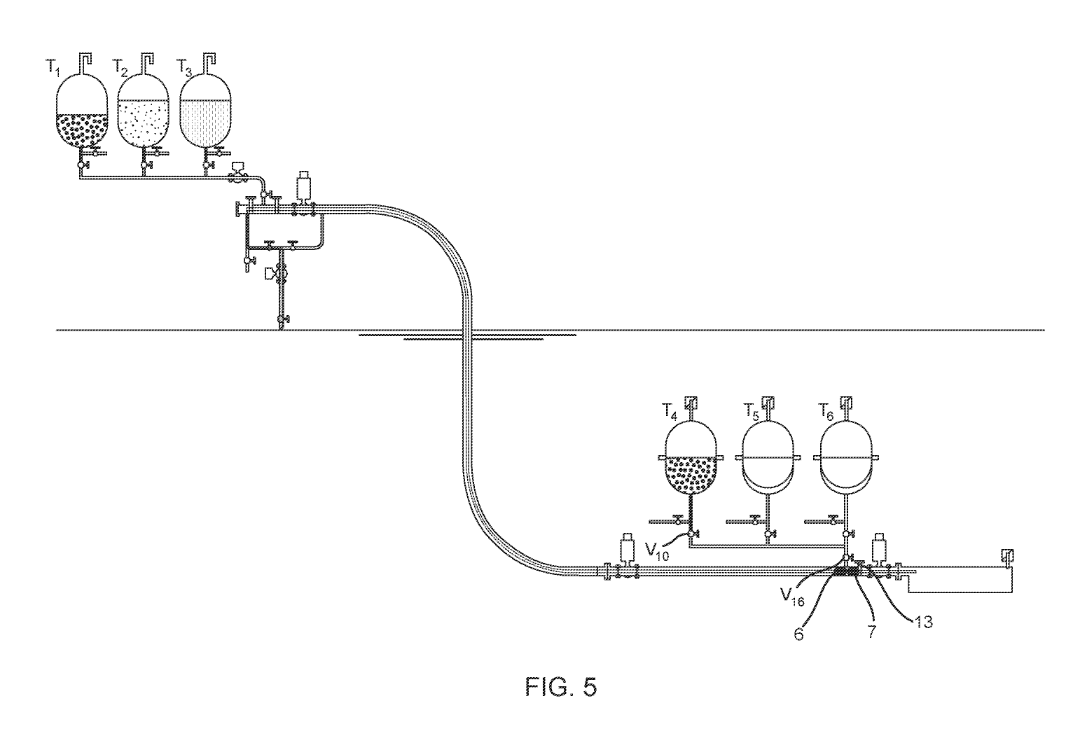

FIG. 5 is a schematic view of a subsea filler line system according to the present invention in a fifth stage of operation.

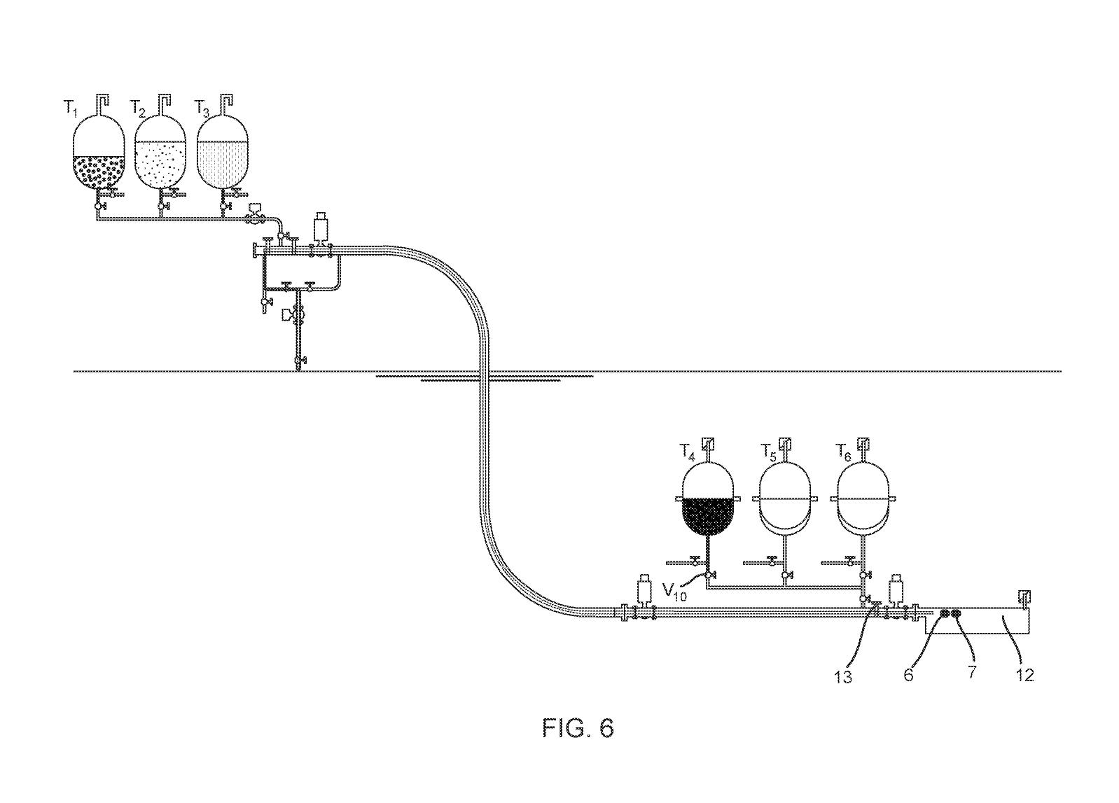

FIG. 6 is a schematic view of a subsea filler line system according to the present invention in a sixth stage of operation.

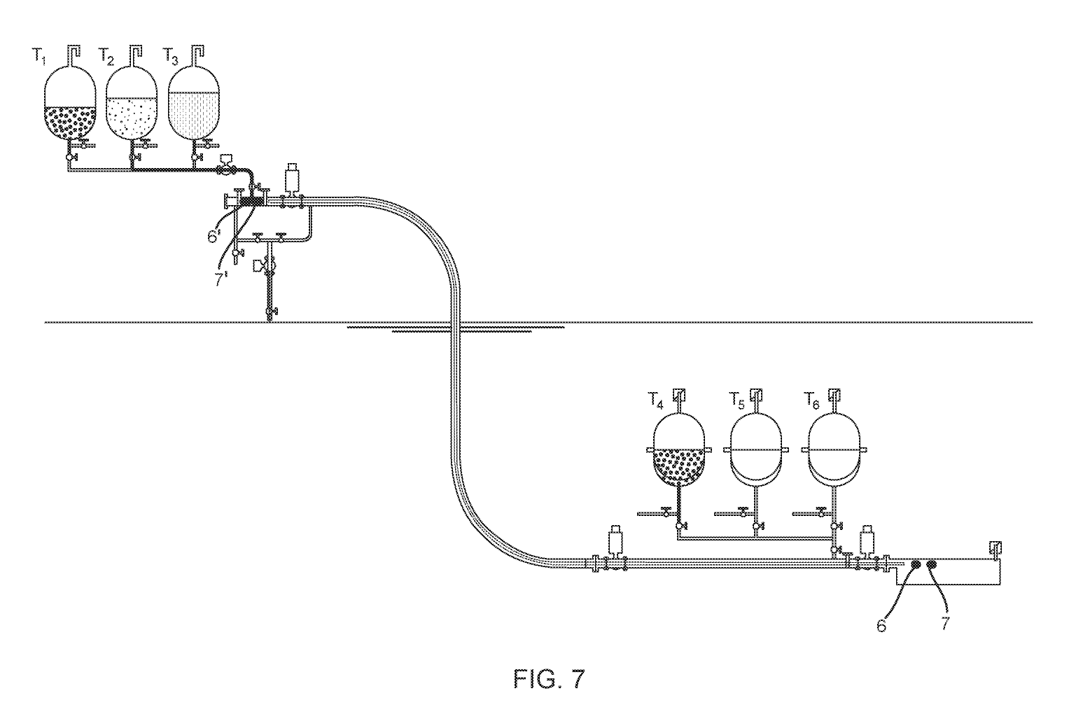

FIG. 7 is a schematic view of a subsea filler line system according to the present invention in a seventh stage of operation.

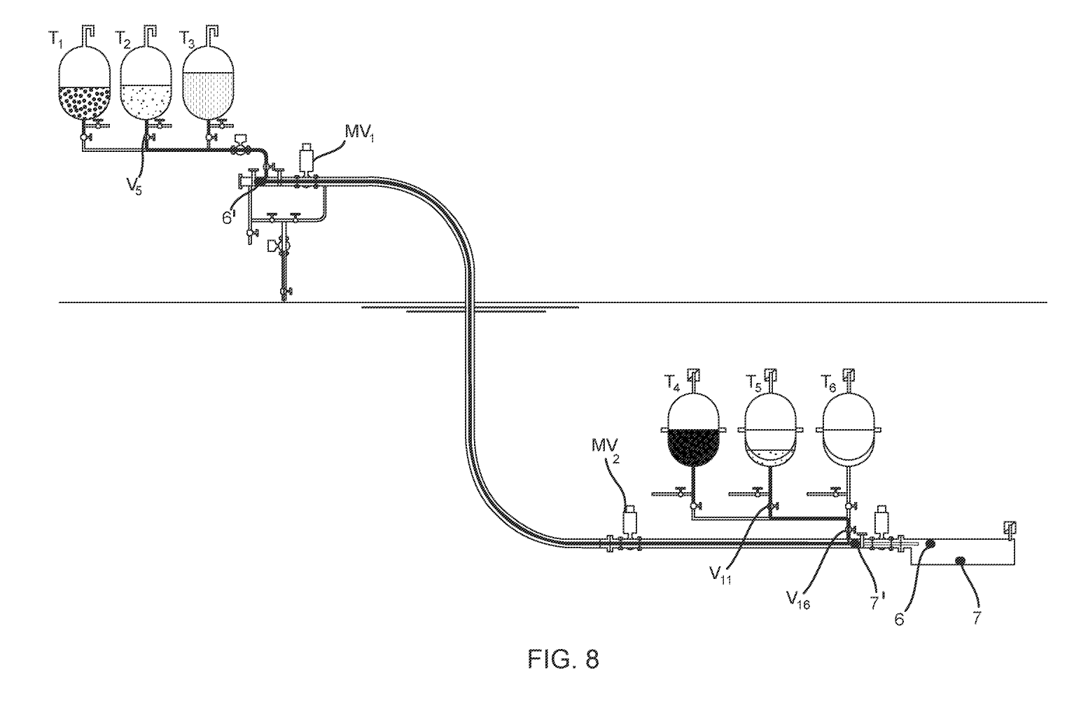

FIG. 8 is a schematic view of a subsea filler line system according to the present invention in an eighth stage of operation.

Reference is first made to FIG. 1 which shows, though kind of schematic, a complete subsea filler line system where a master fluid conduit 1 extends from three tanks T₁, T₂, T₃ on the surface of the water to three tanks T₄, T₅, T₆ located on the seabed. Each tank T₁, T₂, T₃ contain a unique liquid or fluid and will normally be installed onboard a surface vessel or surface facility. Each unique fluid is to be transported as a batch to a dedicated seabed tank T₄, T₅, T₆ via the master fluid conduit 1. A purge fluid is to be sent through the master fluid conduit 1 between each batch to be transported. As previously stated, a main objective with the present invention is to keep the respective fluids isolated from each other, i.e. that the various fluids are not able to contaminate each other during such transfer from the sea surface to the seabed, even if one and the same master fluid conduit 1 is to be used for all the fluids.

The filler pipe material will typically be either a corrosion resistant material or typical high strength carbon steel with protective coating. The material needs to be compatible with the fluids to be transferred.

The respective tanks T₁, T₂, T₃ are interconnected by a first manifold Mi ending in a first upper end of the master fluid conduit 1. Each tank T₁, T₂, T₃ is in turn connected to an inlet pipe having an inlet valve V₁, V₂, V₃ that enables filling up the tanks T₁, T₂, T₃ with respective liquids or fluids. Further, each tank T₁, T₂, T₃ is provided with an outlet pipe having an outlet valve V₄, V₅, V₆ that enables drainage of the respective tanks T₁, T₂, T₃ into the master fluid conduit 1. Each tank T₁, T₂, T₃ is provided with a vent pipe on top to be able to ventilate each tank according to their respective filling level or degree. The first manifold M₁ is provided with a product pump P₁ in order to boost the pressure of the fluid to be transported.

At the first surface end of the master fluid conduit 1, a pig launcher 2 is provided, which pig launcher 2 is defined by a first and second pig stopper 3, 4, a pig launcher door 5, and two pigs 6, 7 ready to be launched, one at the time. Downstream of the second pig stopper 4, a first main flow valve MV₁ is arranged directly on the master fluid conduit 1, which main flow valve MV₁ is able to completely shut off the flow in the master fluid conduit 1.

A bypass loop BL is arranged on the first upper end of the master fluid conduit 1, which bypass loop BL starts upstream of the first pig stopper 3 and ends downstream of the first main flow valve MV₁.

The bypass loop BL is connected to a purge fluid inlet pipe 8, which is able to supply purge fluid by activating a purge fluid pump PP arranged on said purge fluid inlet pipe 8. Two shut off valves V₇ and V₈ are arranged into the bypass loop BL, one on each side of the junction where the purge fluid inlet pipe 8 is connected to the bypass loop BL. The bypass loop BL is also connected to another supply pipe 9 having a shut off valve V₉.

All the above described elements are located on the sea surface, normally on a floating vessel or similar, fixed platform or on shore. The three dedicated storage tanks T₄, T₅, T₆ are located on the seabed and are supposed to be filled up as desired via the master fluid conduit 1. Each tank T₄, T₅, T₆ can be of a collapsible design, i.e. be a rubber bladder 11 which is partly filled with seawater and a diaphragm defining a partition between a dedicated liquid or fluid and the seawater within the bladder 11.

The respective tanks T₄, T₅, T₆ are interconnected by a second manifold M₂ ending in a second lower end of the master fluid conduit 1. Each tank T₄, T₅, T₆ is in turn connected to an inlet pipe having an inlet valve V₁₀, V₁₁, V₁₂ that enables filling up the tanks T₄, T₅, T₆ with respective liquids or fluids. Further, each tank T₄, T₅, T₆ is provided with an outlet pipe having an outlet valve V₁₃, V₁₄, V₁₅ that enables draining from the respective tanks T₄, T₅, T₆ into a dedicated gear on a subsea installation. Each tank T₄, T₅, T₆ is provided with a vent pipe filter 10 on top to be able to ventilate each tank according to their respective filling level or degree. The second manifold M₂ is provided with a main inlet valve V₁₆ on the junction from the master fluid conduit 1.

At the second lower end of the master fluid conduit 1, a pig receiver 12 is provided, which pig receiver 12 is defined by a third pig stopper 13, two more master valves MV₂ and MV₃ arranged directly on the master fluid conduit 1.

Upstream of the third pig stopper 13 the second main flow valve MV₂ is arranged, and downstream the third pig stopper 13 the third main flow valve MV₃ is arranged, which main flow valves MV₂ and MV₃ are able to completely shut off the flow in the master fluid conduit 1. The pig receiver may have a filter 14 and can be retrievable to reclaim the pigs 6, 7 after use. Further, the lower end of the master fluid conduit 1 can be joined by means of respective clamps 15 in order to be able to retrieve the entire or parts of the subsea assembly to the surface, if necessary or desired, for example if maintenance work is to be performed.

An operational sequence will now be described with reference to FIGS. 1 to 8 that show various stages of such operation.

FIG. 1 shows the initial stage where the pig launcher 2 is emptied for purge fluid behind the first main flow valve MV₁ and the pig launcher door 5 opens. The first and second pigs 7, 6 are placed into the pig launcher 2 between the first and second pig stoppers 3, 4. Then the pig launcher door 5 is closed. An outlet valve V₄ from the tank T₁ is opened in addition to the first main flow valve MV₁, and the first pig stopper 4 is unlocked to set the first pig 7 free. The product pump P₁ starts feeding the first product from tank T₁ in between the respective pigs 6, 7. The first pig 7 displaces the purge fluid in the master fluid conduit 1 out of the conduit. The second pig 6 closes behind.

FIG. 2 shows a second stage where the product pump P₁ is feeding as desired until the first pig 7 is stopped by the third pig stopper 13. Then the subsea valves V₁₆ and V₁₀ are opened in order to open up the passage to storage tank T₄ and the first product is then filled into the dedicated tank T₄.

FIG. 3 shows a third stage when the correct volume of the first product is pumped into the dedicated storage tank T₄, and the outlet valve V₄ from the tank T₁ will be closed. Purge fluid is now pumped via purge fluid inlet pipe 8 up behind the second pig 6 by means of the purge fluid pump PP. The purge fluid displaces the first product in the master fluid conduit 1 up into the subsea storage tank T₄.

FIG. 4 shows the above situation in a fourth stage when the second pig 6 is on its way down to the third pig stopper 13 and has just passed the second main flow valve MV₂. Thus it is to be understood that the first fluid is in front of the second pig 6, while the purging fluid is behind the second pig 6.

FIG. 5 shows a fifth stage where the second pig 6 has been stopped against the first pig 7 at the third pig stopper 13. Now the valves V₁₆ and V₁₀ to the subsea storage tank 4 are closed.

FIG. 6 shows a sixth stage when the third pig stopper 13 is opened up and both the first and second pigs 7, 6 are forced into the pig receiver 12 together with purging fluid.

FIG. 7 shows a seventh stage where the procedure according to FIG. 1 is repeated with product number 2 to be drained from a second surface tank T₂ and then transported to a second subsea storage tank T₅ . This is performed by use of a second set of pigs 6′, 7′.

FIG. 8 shows an eight stage similar to the FIG. 2 situation where the second fluid is in transfer from the surface tank T₂ to the subsea storage tank T₅ with respective valves V₅, MV₁, MV₂, V₁₆ and V₁₁ in open position.

The transfer of a third fluid from a third surface tank T₃ to a third subsea storage tank T₆ will take place in similar manner by use of a third set of pigs and respective valves V₆, MV₁, MV₂, V₁₆ and V₁₂ to be open and closed.

Thus it is to be understood that a subsea filler line system adapted to transport different types of fluids in separate batches through one single supply conduit, or flexible line, from the sea surface to respective dedicated storage tanks, or vessels, installed on the seabed, is provided. This system includes respective valves and control systems to operate the subsea filler line system. The subsea filler line system includes at least two pigs adapted to be pushed by the transported fluid through said supply conduit, or flexible line, which pigs further provides a barrier between the respective fluids in front of and behind each pig, thus being able to define respective fluid batches between following pigs, each fluid batch being directed by means of valves through an inlet into said supply conduit and an outlet from said supply conduit and further on to the respective dedicated storage tanks, or vessels, on the seabed.

In turn, the subsea storage tanks will be individually connected to pumps to transfer fluids from the subsea storage tanks to the injection points of the subsea system. This pump system may either be located at the subsea end of the fill pipe system or of the subsea template/process system, where typical electrical power and controls will be available.

As indicate also a method for transporting various fluids trough a master flow conduit from the surface to seabed installed tanks or vessels is provided, where respective pig sets are used in combination with a pig launcher and a pig receiver in addition to a number of valves, branch off pipes and a purging fluid, to enable separate transfer of fluid batches, which is enabled in that predetermined valves are operated either to open up or shut down a flow, in combination with operation of the pig launcher to send out one pig at the time to create a fluid partition between each fluid batch transported through said master flow conduit.

1. A subsea filler line system adapted to transport different types of fluids in separate batches through one single supply conduit, or flexible line, from the sea surface to respective dedicated storage tanks, or vessels, installed on the seabed, said system includes respective valves and control systems to operate the subsea filler line system, wherein said subsea filler line system includes at least two pigs adapted to be pushed by the transported fluid through said supply conduit, or flexible line, which pigs further provide a barrier between the respective fluids in front of and behind each pig, thus being able to define respective fluid batches between following pigs, each fluid batch being directed by means of valves through an inlet into said supply conduit and an outlet from said supply conduit and further on to the respective dedicated storage tanks, or vessels, on the seabed.

2. The subsea filler line system according to claim 1, wherein said subsea filler line system includes a pig launcher comprising a pig stopper able to both retain a pig and release a pig into said supply conduit.

3. The subsea filler line system according to claim 2, wherein said pig launcher comprises said fluid inlet and said pig stopper, which inlet and pig stopper is spaced apart by at least on pig length.

4. The subsea filler line system according to claim 1, wherein said subsea filler line system includes a pig lock adjacent to the subsea storage tanks comprising a pig stopper able to both retain a pig and discharge a pig into a pig receiver, which pig launcher, as an option, can be retrievable.

5. The subsea filler line system according to claim 4, wherein said pig lock comprises said fluid outlet and said pig stopper, which outlet and pig stopper is spaced apart by at least on pig length.

6. The subsea filler line system according to claim 1, wherein said subsea filler line system includes a battery of subsea storage tanks interconnected by a pipe manifold, which pipe manifold has a respective branch pipe to each individual storage tank, each respective branch pipe being provided with an inlet valve able to shut off/open up the flow to said storage tank by means of said control system.

7. The subsea filler line system according to claim 6, wherein each subsea storage tank, or respective branch pipe, includes a fluid pipe with a shut off/open up valve extending to a dedicated equipment on a subsea installation, said valve being operated by means of said control system.

8. The subsea filler line system according to claim 1, wherein said single supply conduit includes a first shut off/open up mainline valve adjacent to the pig launcher and a second shut off/open up mainline valve adjacent to the pig lock on the seabed, which valves being operable by means of said control system and enables installation/replacement of said single supply conduit.

9. The subsea filler line system according to claim 1, wherein said single supply conduit includes a third shut off/open up mainline valve adjacent to, but in the extension of the pig lock on the seabed, which valve being operated by means of said control system and enables isolation of the filler line system when replacing the pig receiver.

10. A method for transporting various fluids through a master flow conduit from the surface to seabed installed tanks or vessels, where respective pig sets are used in combination with a pig launcher and a pig receiver in addition to a number of valves, branch off pipes and a purging fluid, to enable separate transfer of fluid batches, said method comprising the step of:
operating predetermined valves either to open up or shut down a flow, in combination with operation of the pig launcher to send out one pig at a time to create a fluid partition between each fluid batch transported through said master flow conduit.

11. The subsea filler line system according to claim 2, wherein said subsea filler line system includes a pig lock adjacent to the subsea storage tanks comprising a pig stopper able to both retain a pig and discharge a pig into a pig receiver, which pig launcher, as an option, can be retrievable.

12. The subsea filler line system according to claim 3, wherein said subsea filler line system includes a pig lock adjacent to the subsea storage tanks comprising a pig stopper able to both retain a pig and discharge a pig into a pig receiver, which pig launcher, as an option, can be retrievable.

13. The subsea filler line system according to claim 2, wherein said subsea filler line system includes a battery of subsea storage tanks interconnected by a pipe manifold, which pipe manifold has a respective branch pipe to each individual storage tank, each respective branch pipe being provided with an inlet valve able to shut off/open up the flow to said storage tank by means of said control system.

14. The subsea filler line system according to claim 3, wherein said subsea filler line system includes a battery of subsea storage tanks interconnected by a pipe manifold, which pipe manifold has a respective branch pipe to each individual storage tank, each respective branch pipe being provided with an inlet valve able to shut off/open up the flow to said storage tank by means of said control system.

15. The subsea filler line system according claim 4, wherein said subsea filler line system includes a battery of subsea storage tanks interconnected by a pipe manifold, which pipe manifold has a respective branch pipe to each individual storage tank, each respective branch pipe being provided with an inlet valve able to shut off/open up the flow to said storage tank by means of said control system.

16. The subsea filler line system according to claim 5, wherein said subsea filler line system includes a battery of subsea storage tanks interconnected by a pipe manifold, which pipe manifold has a respective branch pipe to each individual storage tank, each respective branch pipe being provided with an inlet valve able to shut off/open up the flow to said storage tank by means of said control system.

17. The subsea filler line system according to claim 2, wherein said single supply conduit includes a first shut off/open up mainline valve adjacent to the pig launcher and a second shut off/open up mainline valve adjacent to the pig lock on the seabed, which valves being operable by means of said control system and enables installation/replacement of said single supply conduit.

18. The subsea filler line system according to claim 3, wherein said single supply conduit includes a first shut off/open up mainline valve adjacent to the pig launcher and a second shut off/open up mainline valve adjacent to the pig lock on the seabed, which valves being operable by means of said control system and enables installation/replacement of said single supply conduit.

19. The subsea filler line system according to claim 4, wherein said single supply conduit includes a first shut off/open up mainline valve adjacent to the pig launcher and a second shut off/open up mainline valve adjacent to the pig lock on the seabed, which valves being operable by means of said control system and enables installation/replacement of said single supply conduit.

20. The subsea filler line system according to claim 5, wherein said single supply conduit includes a first shut off/open up mainline valve adjacent to the pig launcher and a second shut off/open up mainline valve adjacent to the pig lock on the seabed, which valves being operable by means of said control system and enables installation/replacement of said single supply conduit.
